(19) United States
(12) Patent Application Publication
(10) Pub. No.: US 2026/0346104 A1
(43) Pub. Date: Nov. 5, 2026

(54) IMPROVED PICKLEBALL PADDLE AND METHOD

(71) Applicant: SIX ZERO PICKLEBALL PTY LTD, Red Hill, Queensland (AU)

(72) Inventor: Dale YOUNG, Red Hill (AU)

(73) Assignee: SIX ZERO PICKLEBALL PTY LTD, Red Hill, Queensland (AU)

(21) Appl. No.: 19/487,598

(22) PCT Filed: Mar. 11, 2025
(86) PCT No.: PCT/AU2025/050221

§ 371 Date: Nov. 25, 2025

(30) Foreign Application Priority Data
Mar. 11, 2024 (AU) 2024900634

(51) Int. Cl. A63B 59/42; A63B 60/00; A63B 102/08; B32B 5/02; B32B 7/04; B32B 27/38

(52) U.S. Cl. CPC A63B 59/42; A63B 60/004; B32B 5/02; B32B 7/04; B32B 27/38; A63B 2102/08; A63B 2209/023; B32B 2250/40; B32B 2260/021; B32B 2260/046

(57) ABSTRACT

A pickleball paddle including: a handle; a ball striking blade formed integrally with the handle; the handle and the blade being formed from a core layer sandwiched between outer layers to form a unitary body; core layer including a thickness which is substantially greater than thickness of the outer layers, where each of the outer layer comprises one or more layers of composite material yarns that are pre-impregnated with epoxy with at least an outermost layer of the composite material yarn including embedded grit particles that are embedded into the outermost layer of the composite material yarns.

### TECHNICAL FIELD

The present invention relates to an improved pickleball paddle and a method for producing an outer playing surface for a pickleball paddle.

### BACKGROUND

Any references to methods, apparatus or documents of the prior art are not to be taken as constituting any evidence or admission that they formed, or form part of the common general knowledge.

The face material in a pickleball paddle is normally bonded to a core of a pickleball paddle. The most common face material in pickleball paddle includes graphite, carbon fibre, fibreglass and composite materials.

Adding grit to the playing surface of the face material is also known. Some paddles add paint grit to the playing surface of the pickleball paddle which is susceptible to wearing off rather quickly. Other textures or coatings have also been added to the face material which also tend to wear off quickly. There are also legal limits on how much grit can be added to the playing surface of the face material.

In view of the above, it is desirable to improve the wearability of grit on the playing surface provided by the face material.

### SUMMARY OF INVENTION

In an aspect, the invention provides a pickleball paddle comprising:
a handle;
a ball striking blade formed integrally with the handle;
the handle and the blade being formed from a core layer sandwiched between outer layers to form a unitary body;
core layer comprising a thickness which is substantially greater than thickness of the outer layers,
wherein each of said outer layer comprises one or more layers of yarns with composite material that is pre-impregnated with epoxy with at least an outermost layer of said composite material comprising embedded grit particles that are embedded into said outermost layer of the composite material.
   In an embodiment, the composite material comprises carbon fiber yarns. In other embodiment, the composite material may comprises fibreglass or other material such as Kevlar.

In an embodiment, the outer layer comprises a plurality of layers of yarns that are pre-impregnated with epoxy whereby each of said plurality of layers comprises embedded grit particles.

In an embodiment, said thickness of the core layer is shaped along a peripheral part of the blade and body to form an edge extending between the outer layers of the unitary body; and one or more layers of flexible edge tape are bonded to an outer surface of the edge to at least extend between the outer layers.

In an embodiment, the said one or more layers of the tape extend to be flush with respective outer surfaces of the outer layers of the ball striking blade such that no part of the tape covers the outer surface of the blade.

In an embodiment, the said one or more layers of the tape to lap over peripheral portions of the respective outer surfaces of the outer layers of the ball striking blade.

In an embodiment, the edge tape is unidirectional such that the tape is fibre reinforced length-wise to provide directional strength along the edge between the outer layers.

In an embodiment, the edge tape comprises braided fiber composite material, a woven material, nonwoven fibers embedded in a polymeric matrix, a composite resin-based material, natural fibers, metal, carbon, carbon fiber, glass, fiberglass, graphite, boron, basalt, carrot, Kevlar®, Spectra®, poly-para-phenylene-2, 6-benzobisoxazole (PBO), hemp, Bamboo fiber, polycarbonate, Innegra, Bassalt, poly methyl methacrylate, polyamide, polyolefins (e.g, polyethylene), polyurethane, and combinations thereof.

In an embodiment, the edge tape comprises pre-pregnated carbon pre-pregnated carbon, Kevlar or fiberglass and may be a single layer of multiple layers of one material or a combination of materials.

In an embodiment, the core is formed from one or more of the following materials: polymeric foam, polypropylene, polyurethane, polyurethane foam, polyester, thermoplastic polyurethane (TPU), Polystyrene Foam, polyamide, other rigid polymer or glass/carbon filled polymer composite, urethane foam, polypropylene, Nomex® polycarbonamide material, ethylene vinyl acetate (EVA), aluminum, balsa, corrugated cardboard, polyethylene, polyvinyl chloride, a polyethylene vinyl acetate, polymethacrylimide, other polymeric foams, other lightweight elastic foams, liquid crystal elastomers (LCE), elastic polymers, liquid crystalline polymers, other types of wood, other metallic alloys, and combinations.

In another aspect, the invention provides a method of manufacturing an outer playing surface for a pickleball paddle, the method comprising the steps of:
providing one or more layers of composite fibre ply wherein one or more of said fibre ply is pre-pregnated with epoxy;
spreading grit particles across one or more areas of an outer surface of one of said layers of carbon fibre ply;
positioning a top layer of peel ply fabric to cover said one or more areas of the outer surface of the one or more said layers of carbon fibre ply;
pressing the peel ply fabric onto said one or more layers of fibre under elevated temperatures.

In an embodiment, the method further comprises positioning a bottom layer of peel ply fabric such that the one or more layers of carbon fibre ply are sandwiched between the top and bottom layers of peel ply fabric to form a playing surface of a pickleball paddle and wherein the pressing step involves pressing the top and bottom layers of the peel ply fabric.

In an embodiment, the method further comprises positioning a release sheet adjacent the peel ply fabric to facilitate releasing the playing surface of the pickleball paddle after the pressing step is completed.

In an embodiment, the pressing step comprises pressing at least the top layer of the peel ply fabric with a metal sheet, preferably a stainless-steel sheet.

In an embodiment, each of the top and bottom layers of the peel ply fabric are pressed with a respective stainless sheet.

In an embodiment, the pressing step further comprises positioning an outer most layer of a glass sheet and pressing the glass sheet in a direction towards the top layer of the peel ply fabric to achieve a generally flat base.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is an exploded view illustrating the various components used for pressing and forming an outer playing surface 110 for a pickleball paddle in accordance with an embodiment.

FIG. 2A to 2C, 3 and 4 illustrate various views of the cured outer playing surface 110 formed by a method embodiment.

FIG. 5 is an exploded view showing multiple playing surfaces 110 being pressed simultaneously in a press.

FIG. 6 is an exploded view of a pickleball paddle 100 utilizing playing surfaces 1.

FIGS. 7 and 8 illustrate schematic diagrams for depicting a method for forming the outer playing surface for the pickleball paddle.

### DETAILED DESCRIPTION OF PREFERRED EMBODIMENTS

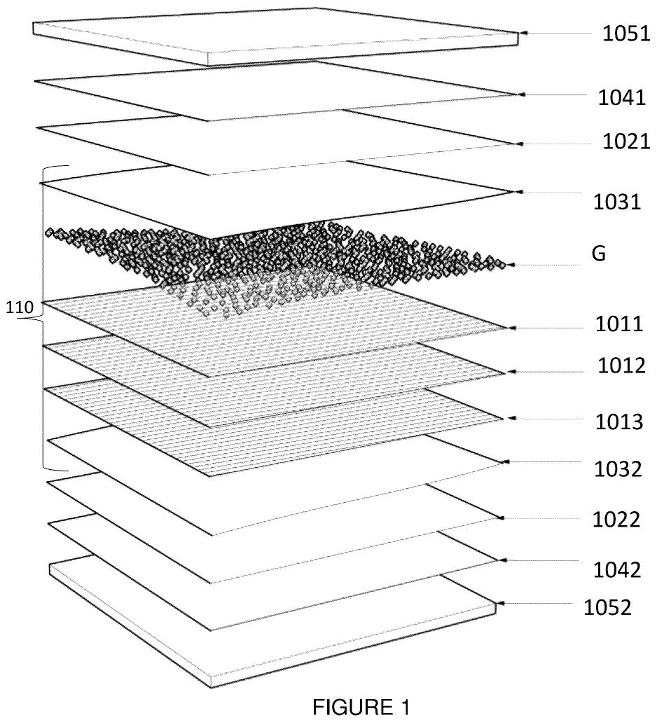

FIG. 1 illustrates an exploded view of a method for forming an outer playing surface for a pickleball paddle. Three plies of unidirectional carbon fibre 1011, 1012 and 1013 that are pre-pregnated with epoxy are layered together such that the fibres in each cabon fibre ply is mutually perpendicular to an adjacent carbon fibre ply. Providing the three layers of carbon fibre in a mutually perpendicular configuration improves strength characteristics for the face material. Grit particles 102 are spread uniformly across an area of top-most/outer carbon fibre ply and thereafter a top layer of peel ply fabric 1301 is positioned to cover the area (with grit particles) of the outermost carbon fibre ply. A hot press moulding machine may be used for undertaking the pressing step whereby the pressing step at a high temperature for a certain amount of time by using any pressing equipment (such as but not limited to a hydraulic press) results in the epoxy resin being configured to flow and fully disperse and impregnate the carbon fibre layers. The pressing step also results in the grit particles becoming embedded into the three layers of the carbon fibre ply 1011, 1012, 1013.

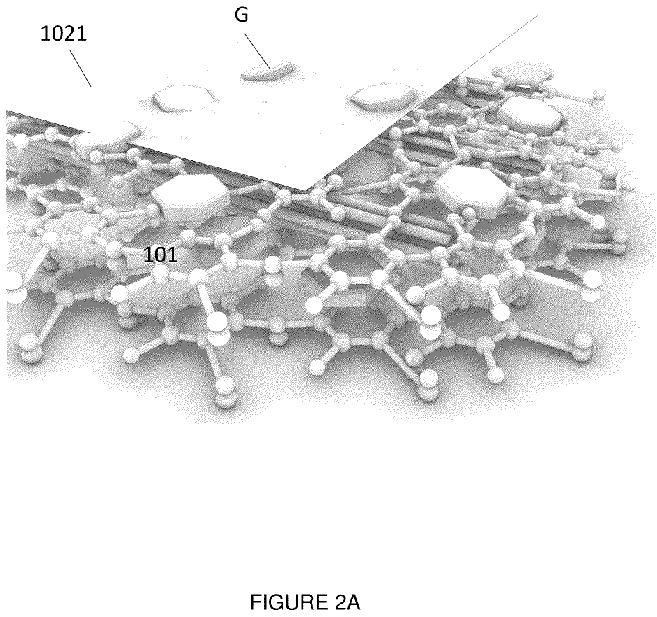

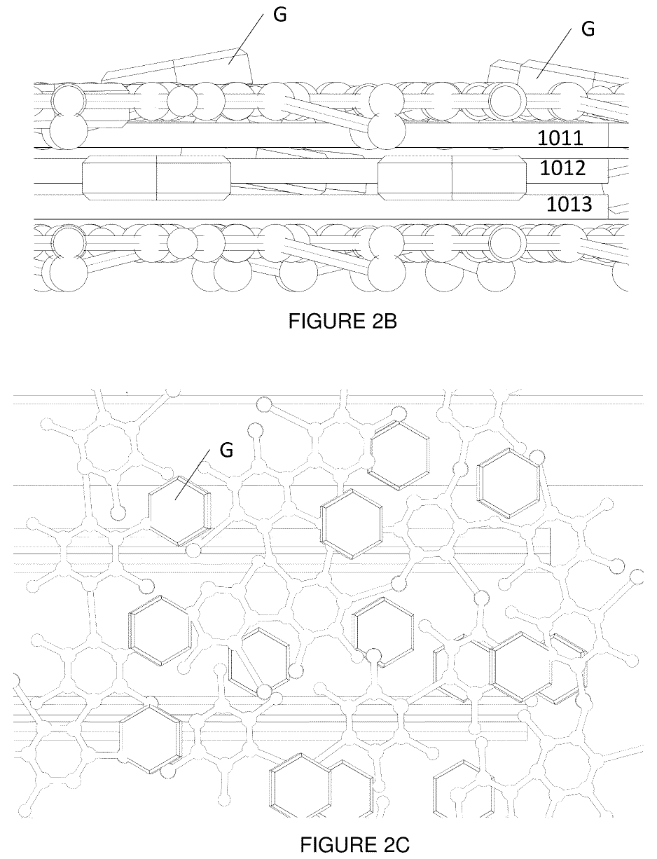

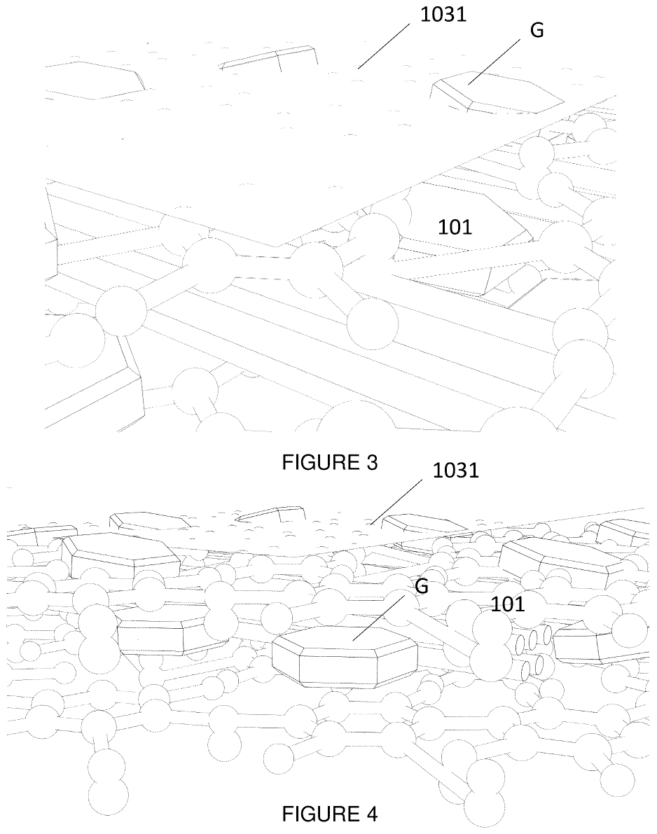

During the curing cycle of the manufacturing process, the peel ply fabric absorbs some of the matrix epoxy resin and becomes an integral part of the laminate. When this fabric (peel ply) is peeled off, the resin between it and the first layer of carbon fiber reinforcement with the embedded grit particles is fractured. This leaves a fresh, clean, roughened surface of matrix resin for the outer surface produced from the aforementioned method. FIG. 2 illustrates the grit particles G becoming embedded into the three layers of carbon fibre ply. Without being bound by theory, it is hypothesized that the method of using the pressing step under heat results in the grit particles becoming firmly embedded within the matrix of the multiple layers of the carbon ply fabric. The curing of the epoxy within the matrix assists with ensuring that the grit particles are firmly embedded within the carbon layers. It is believed that the novel method of preparing the outer playing surface for the pickleball paddle improves the wear resistance and improves longevity of the playing surface with grit particles when compared with previously known method of painting grit to the playing surface of the pickleball paddle.

During the curing cycle of the manufacturing process, the peel ply fabric 1031 and 1032 may absorb some of the matrix epoxy resin and become an integral part of the laminate. When this fabric (peel ply) is peeled off, the resin between it and the first layer of carbon fibre reinforcement is fractured. This leaves a fresh, clean, roughened surface of matrix resin with embedded grit particles, thus the raw texture. FIGS. 3 and 4 illustrate the pressed matrix of the pre-pregnated and cured carbon fibres (denoted generally by 101).

The method of forming the outer playing surface using the pressing method also required the use of top and bottom release sheets 1021 and 1022 that are positioned adjacent the respective top and bottom peel ply layers 1031 and 1032 which enable the pressed carbon ply fabric layers with the top and bottom peel ply fabrics to be easily removed once the pressing step has been completed.

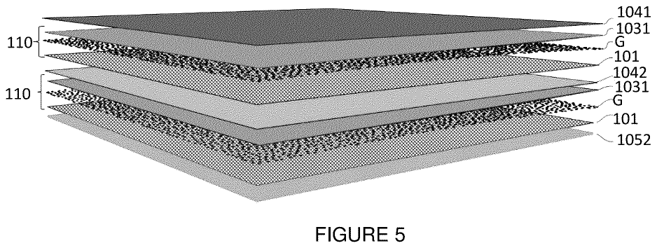

Referring to FIG. 1, the pressing of only one playing surface made from pressing three carbon ply layers with embedded grit particles and sandwiched between top and bottom peel play layers has been shown. However, as shown in FIG. 5, in further embodiments, a plurality of playing surfaces may be produced by separating the components layers of a first outer surface and the component layers of a subsequent outer surface by stainless steel sheets 1041 and 1042 on the top and bottom of the release layers 1021 and 1022 respectively. Top and bottom glass backing layers 1051 and 1052 may be used during the pressing process. For the sake of clarity the release layers have not been shown in FIG. 5. Like reference numerals denote like features which have been previously described.

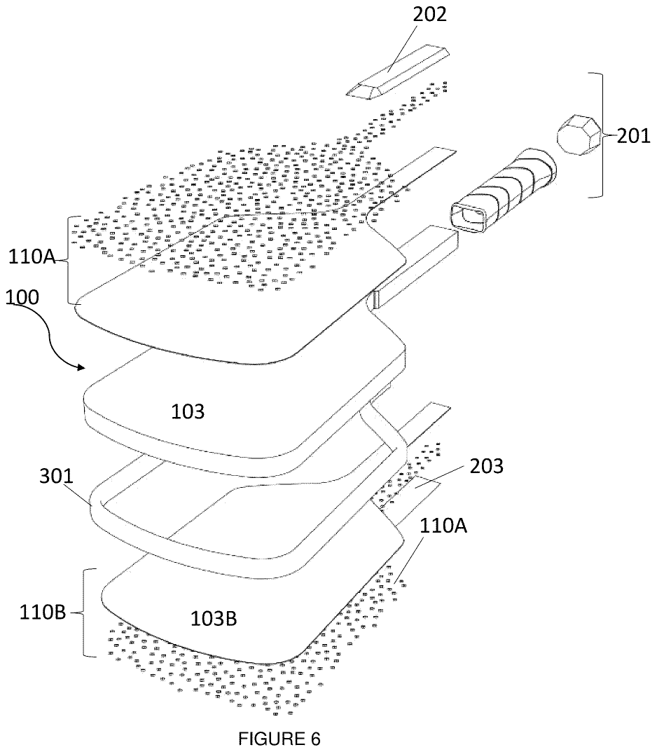

FIG. 6 illustrates the use of a playing surface for manufacturing a pickleball paddle. It is to be understood that the playing surface (generally denoted by 110) may be used for manufacturing any pickleball paddle without departing from the spirit and scope of the invention. The pickleball paddle 100 comprises a core 103 that is sandwiched between two outer layers 110A and 110B which form the playing surface with embedded grit material for the paddle 100. In the presently described embodiment, the handle and the ball striking blade for the pickleball paddle are integrally formed by the core 103 sandwiched between the outer layers 110A and 110B

The core 103 in the present embodiment can be made of any one of the following: foam, honeycomb, polypropylene, polyurethane, polyurethane foam, polyester, thermoplastic polyurethane (TPU), Polystyrene Foam, polyamide, other rigid polymer or glass/carbon filled polymer composite, urethane foam, polypropylene, Nomex® polycarbonamide material, ethylene vinyl acetate (EVA), aluminium, balsa, corrugated cardboard, polyethylene, polyvinyl chloride, a polyethylene vinyl acetate, polymethacrylimide, other polymeric foams, other lightweight elastic foams, liquid crystal elastomers (LCE), elastic polymers, liquid crystalline polymers, other types of wood, other metallic alloys, and combinations thereof.

As shown in the sectional views, the core layer 103 comprises a thickness which is substantially greater than thickness of the outer layers 110A and 110B. The thickness of the core layer 103 is shaped to form a convex edge which extends between the outer layers 102 and 107 all around the paddle 100. The handle portion denoted by 201 comprises handle dampeners 202 and 203 and end cap portion 204 to provide a slightly thicker configuration for the handle 201 relative to the blade portion of the paddle 100.

One or more layers of flexible edge tape may be is bonded to the outer convex edge to extend between the outer layers 110A and 110B. In a first possible embodiment in which the edge tape 301 may be flush with the respective outer surfaces of the outer layers 110A and 110B. In a second possible embodiment in which the edge tape 301 that laps over peripheral portions of the respective outer surfaces of the outer layers 102 and 107.

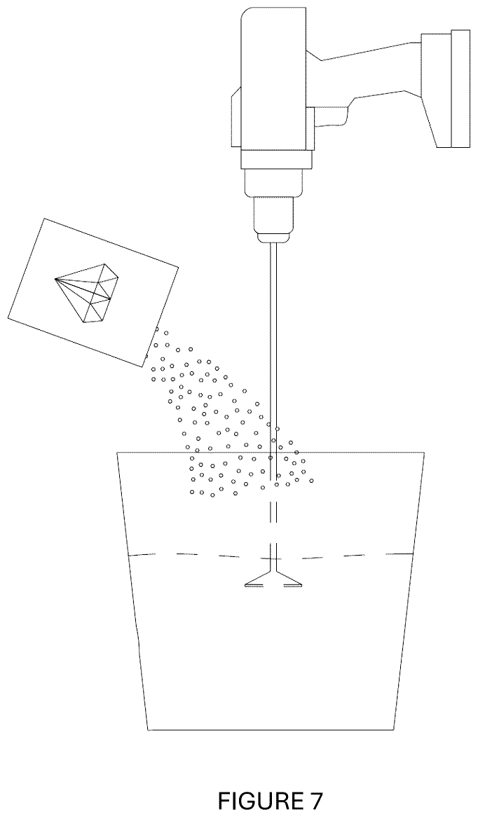

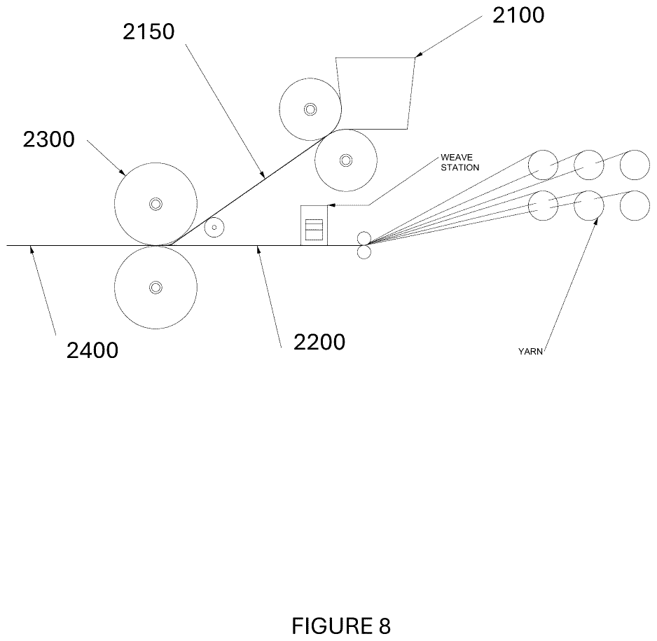

Referring to FIG. 7, a grit infused epoxy formulation is prepared and used for forming an epoxy sheet that is infused with diamond grit before being cured to form the epoxy sheet. As shown in FIG. 7, to incorporate diamond grit, the epoxy is mixed until it reaches a viscous state, at which point diamond powder is introduced at a volume of 10-60% by weight. The epoxy-grit mixture 2100 is then blended using a powered mixer to ensure uniform distribution of the diamond particles. Once the diamond grit powder is evenly dispersed, the epoxy resin solidifies again before being fed into the extrusion machine. A thin sheet of the diamond-impregnated epoxy is then extruded and compressed onto the fiber laminate, forming the pre-impregnated sheet material 2150. As shown in FIG. 8, the pre-pregnated sheet material 2150.

The pre-pregnated sheet material 2150 is compressed onto a woven composite fabric 2200 using compression rollers 2300 to form the pre-pregnated fabric 2400. As explained in the earlier sections, the epoxy resin mixture is configured to flow and fully disperse and impregnate the fabric. The pressing step also results in the grit particles becoming embedded into the fabric layers.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1-15. (canceled)

16. A pickleball paddle comprising:
a handle;
a ball striking blade formed integrally with the handle;
the handle and the blade being formed from a core layer sandwiched between outer layers to form a unitary body; and
the core layer comprising a thickness which is substantially greater than a thickness of the outer layers,
wherein each of said outer layer comprises one or more layers of composite material yarns that are pre-impregnated with epoxy with at least an outermost layer of said composite material yarn comprising embedded grit particles that are embedded into said outermost layer of the composite material yarns.

17. The pickleball paddle in accordance with claim 16, wherein the outer layer comprises a plurality of layers of composite material yarns that are pre-impregnated with epoxy whereby each of said plurality of layers comprises embedded grit particles.

18. The pickleball paddle in accordance with any claim 17, wherein said thickness of the core layer is shaped along a peripheral part of the blade and body to form an edge extending between the outer layers of the unitary body; and one or more layers of flexible edge tape are bonded to an outer surface of the edge to at least extend between the outer layers.

19. The pickleball paddle in accordance with claim 18, wherein the one or more layers of the tape extend to be flush with respective outer surfaces of the outer layers of the ball striking blade such that no part of the tape covers the outer surface of the blade.

20. The pickleball paddle in accordance with claim 19, wherein the one or more layers of the tape to lap over peripheral portions of the respective outer surfaces of the outer layers of the ball striking blade.

21. The pickleball paddle in accordance with claim 20, wherein the edge tape is unidirectional such that the tape is fibre reinforced length-wise to provide directional strength along the edge between the outer layers.

22. The pickleball paddle in accordance with claim 21, wherein the edge tape comprises braided fiber composite material, a woven material, nonwoven fibers embedded in a polymeric matrix, a composite resin-based material, natural fibers, metal, carbon, carbon fiber, glass, fiberglass, graphite, boron, basalt, carrot, Kevlar®, Spectra®, poly-para-phenylene-2, 6-benzobisoxazole (PBO), hemp, Bamboo fiber, polycarbonate, Innegra, Bassalt, poly methyl methacrylate, polyamide, polyolefins (e.g, polyethylene), polyurethane, and combinations thereof.

23. The pickleball paddle in accordance with claim 16, wherein the edge tape comprises pre-pregnated carbon pre-pregnated carbon, Kevlar or fiberglass, and the edge tape further comprises one or more layers of one material or a combination of materials.

24. The pickleball paddle in accordance with claim 16, wherein the core is formed from one or more of the following materials: polymeric foam, polypropylene, polyurethane, polyurethane foam, polyester, thermoplastic polyurethane (TPU), Polystyrene Foam, polyamide, other rigid polymer or glass/carbon filled polymer composite, urethane foam, polypropylene, Nomex® polycarbonamide material, ethylene vinyl acetate (EVA), aluminum, balsa, corrugated cardboard, polyethylene, polyvinyl chloride, a polyethylene vinyl acetate, polymethacrylimide, other polymeric foams, other lightweight elastic foams, liquid crystal elastomers (LCE), elastic polymers, liquid crystalline polymers, other types of wood, other metallic alloys, and combinations thereof.

25. A method of manufacturing an outer playing surface for a pickleball paddle, the method comprising steps of:
providing one or more layers of composite material ply wherein one or more of said composite material ply is pre-pregnated with epoxy;
spreading grit particles across one or more areas of an outer surface of one of said layers of composite material ply;
positioning a top layer of peel ply fabric to cover said one or more areas of the outer surface of the one or more said layers of carbon fibre ply; and
pressing the peel ply fabric onto said one or more layers of composite material.

26. The method in accordance with claim 25, further comprising positioning a bottom layer of peel ply fabric such that the one or more layers of composite material ply are sandwiched between the top and bottom layers of peel ply fabric to form a playing surface of a pickleball paddle and wherein the pressing step involves pressing the top and bottom layers of the peel ply fabric.

27. The method in accordance with claim 26, further comprising positioning a release sheet adjacent the peel ply fabric to facilitate releasing the playing surface of the pickleball paddle after the pressing step is completed.

28. The method in accordance with claim 27, wherein the pressing step comprises pressing at least the top layer of the peel ply fabric with a metal sheet, preferably a stainless-steel sheet.

29. The method in accordance with claim 28, wherein each of the top and bottom layers of the peel ply fabric are pressed with a respective stainless sheet.

30. The method in accordance with claim 29, wherein the pressing step further comprises positioning an outer most layer of a glass sheet and pressing the glass sheet in a direction towards the top layer of the peel ply fabric.
